(19) United States
(12) Patent Application Publication
(10) Pub. No.: US 2021/0285626 A1
(43) Pub. Date: Sep. 16, 2021

(54) MOUNTING SYSTEMS FOR LUMINAIRES

(71) Applicant: ABL IP Holding LLC, Atlanta, GA (US)

(72) Inventors: Patrick M. Tweel, Atlanta, GA (US); John Gregory, Decatur, GA (US); Reza Khosh, Grayson, GA (US); Daniel C. Edwards, Smyrna, GA (US); Andrew L. Solinski, Canton, GA (US)

(21) Appl. No.: 17/199,549

(22) Filed: Mar. 12, 2021

Related U.S. Application Data
(60) Provisional application No. 62/988,644, filed on Mar. 12, 2020.

(51) Int. Cl. F21V 21/088; F21V 19/00; F21S 4/20

(52) U.S. Cl. CPC F21V 21/088; F21Y 2115/10; F21S 4/20; F21V 19/003

(57) ABSTRACT

A light fixture may include a light engine, a housing, and a mounting clip, and the light engine may include a mounting substrate, at least one light source, and at least one electronics board. The mounting clip may mount the at least one light source and the at least one electronics board on the mounting substrate, and the mounting clip may also mount the light engine on the housing. The light fixture may include an end cap that is removably attached to an end of the housing of the light fixture. In some cases, the light fixture may include a mounting system that includes at least one of a mounting bracket or an alignment bracket.

### REFERENCE TO RELATED APPLICATION

This application claims the benefit of U.S. Provisional Patent Application No. 62/988,644, filed on Mar. 12, 2020 and entitled MOUNTING SYSTEMS FOR LUMINAIRES, the content of which is hereby incorporated by reference in its entirety.

### FIELD OF THE INVENTION

Embodiments of the present invention relates to mounting systems for luminaires that reduce or eliminate the use of fasteners and simplify the assembly and installation process.

### BACKGROUND

A light fixture or luminaire includes many components that must be assembled together and/or utilized to support the luminaire in a particular location. Typically, mechanical fasteners are used to achieve the desired attachment. However, mechanical fasteners can be costly, add components to the overall assembly, add inventory that must be tracked, and require tools with specific torque requirements, thereby increasing areas where a mistake can be made during assembly, repair, or removal. Such fasteners also make accessing light fixtures in the field (e.g., for installation, repair, or removal) difficult as they are typically not removed easily.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

According to certain embodiments, a light fixture includes a light engine and a mounting clip. The light engine includes a mounting substrate having a front surface, a rear surface opposite the front surface, and at least one aperture extending through the mounting substrate. The light engine also includes at least one light source and at least one electronics board. The mounting clip includes a central body having a first surface, a second surface opposite the first surface, a first side edge, and a second side edge opposite the first side edge. The mounting clip also includes at least one first finger extending from the first surface and at least one second finger extending from the second surface. In certain embodiments, the at least one first finger extends through the at least one aperture of the mounting substrate and retains the at least one light source on the front surface of the mounting substrate. In various embodiments, the at least one second finger retains the at least one electronics board on the second surface of the mounting clip.

According to some embodiments, a light fixture includes a light engine, a fixture housing, and a mounting clip. The fixture housing may include a pair of side walls defining a housing cavity, and each side wall includes a ledge extending into the housing cavity. The mounting clip includes a central body having a first surface, a second surface opposite the first surface, a first side edge, and a second side edge opposite the first side edge. The mounting clip also includes at least one first finger extending from the first surface and a plurality of attachment arms extending from the second surface. In certain embodiments, the at least one first finger is engaged with the light engine. In various embodiments, the plurality of attachment arms engage the ledges of the side walls of the housing such that the light engine is attached to the housing via the mounting clip.

According to various embodiments, a light fixture includes a fixture housing and an end cap. The fixture housing includes a pair of side walls and a transverse wall extending between the side walls. The side walls and transverse wall extend between a first end and a second end of the fixture housing, and the side walls and transverse wall define a housing cavity. In certain embodiments, the transverse wall defines an aperture proximate to the first end of the housing. The end cap may be removably mounted to the first end of the fixture housing. In some embodiments, the end cap includes an inner side, an outer side, a lever lock supported on the inner side, and a lever retained on the end cap via the lever lock. In various embodiments, the lever is movable along an axis between a first position and a second position. In certain aspects, in the first position, the lever is engaged with the aperture of the fixture housing, and, in the second position, the lever is disengaged from the aperture of the fixture housing.

According to certain embodiments, a light fixture includes a fixture housing having a pair of side walls and a transverse wall extending between the side walls. The side walls and transverse wall extend between a first end and a second end of the fixture housing, and wherein the side walls and transverse wall define a housing cavity. The light fixture also includes a mounting system having at least one mounting bracket that includes a mounting plate and a retention wing. The retention wing is pivotably connected to the mounting plate such that the mounting plate is movable between a first rotational position in which the retention wing extends upwardly from the mounting plate and a second rotational position in which the retention wing extends downwardly from mounting plate.

### BRIEF DESCRIPTION OF THE FIGURES

FIG. 1 is an exploded view of a light fixture according to certain embodiments.

FIG. 2 is another exploded view of the light fixture of FIG. 1 according to certain embodiments.

FIGS. 3A-C illustrate a housing of the light fixture of FIG. 1 according to certain embodiments.

FIGS. 4A-C illustrate a mounting substrate of the light fixture of FIG. 1 according to certain embodiments.

FIG. 5 illustrates a light engine of the light fixture of FIG. 1 according to certain embodiments.

FIG. 6 illustrates an electronics board of the light fixture of FIG. 1 according to certain embodiments.

FIG. 7 illustrates a mounting clip of the light fixture of FIG. 1 according to certain embodiments.

FIG. 8 illustrates the mounting substrate and mounting clips of the light fixture of FIG. 1 according to certain embodiments.

FIG. 9 illustrates a portion of a printed circuitry board mounted on the mounting substrate of the light fixture of FIG. 1 according to certain embodiments.

FIG. 10 illustrates the light engine mounted on the mounting substrate of the light fixture of FIG. 1 according to certain embodiments.

FIGS. 11A-G illustrate portions of the assembled light fixture of FIG. 1 according to certain embodiments.

FIGS. 12A-B illustrate an end cap of the light fixture of FIG. 1 according to certain embodiments.

FIG. 13 illustrates a lever lock of the light fixture of FIG. 1 according to certain embodiments.

FIGS. 14A-B illustrates a lever of the light fixture of FIG. 1 according to certain embodiments.

FIGS. 15A-B illustrates the housing and the end cap of the light fixture of FIG. 1 with the end cap in a locked configuration and an unlocked configuration.

FIG. 16 is an end view of another light fixture according to certain embodiments.

FIG. 17 is a top view of the light fixture of FIG. 16.

FIGS. 18A-C illustrate additional views of the light fixture of FIG. 16.

FIG. 19 is another side view of the light fixture of FIG. 16.

FIG. 20 illustrates two housings for a light fixture according to certain embodiments.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Terms such as “upper, “lower,”, “top,”, and “bottom” refer only to the orientation of the examples in the figures. Light fixtures embodying the invention may be used in other orientations, for example an orientation in which an “top” or “upper” surface as shown in the figures faces downward in practice.

Embodiments of the present invention relate to light fixtures, including but not limited to, suspended, surface mounted, and recessed fixtures. While the inventions disclosed herein are not limited to a particular fixture, various features described herein may be particularly suitable for use on linear fixtures (i.e., light fixtures having a fixture length that is greater than the fixture width).

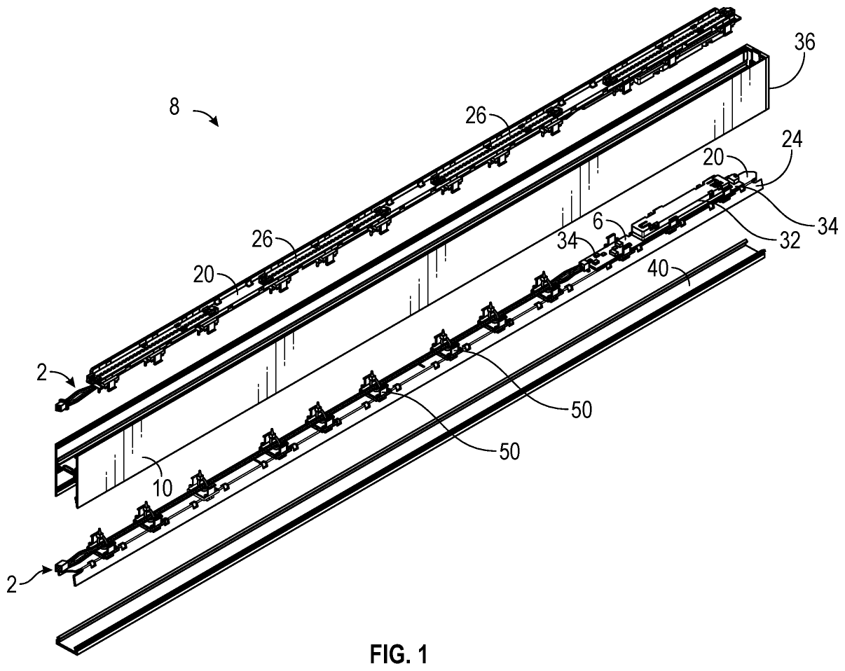

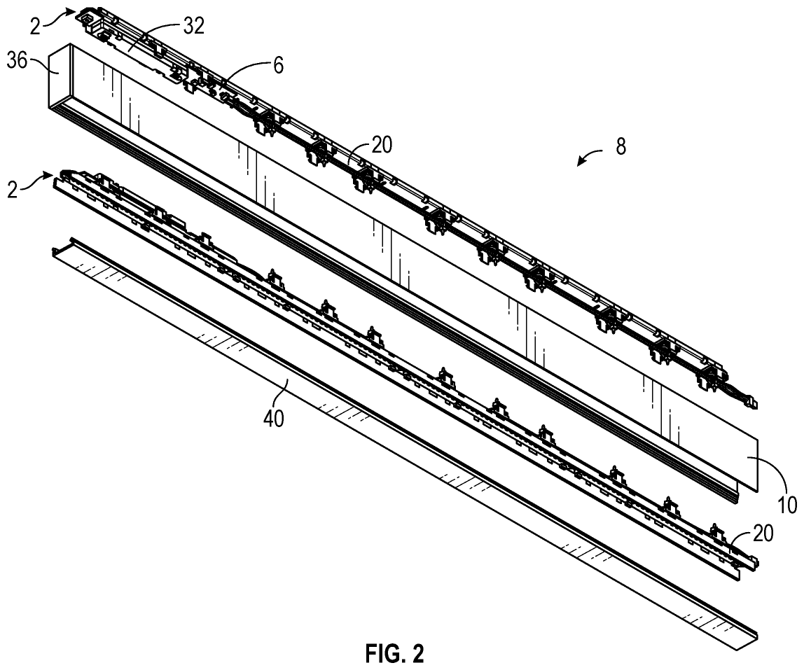

FIGS. 1 and 2 illustrate an example of a light fixture 8 according to various embodiments. The light fixture 8 of FIGS. 1 and 2 is a linear light fixture, although it need not be in other embodiments. As illustrated, the light fixture 8 may include at least one light engine 2 that is mounted on a housing 10. In the embodiment illustrated in FIGS. 1 and 2, the light fixture 8 includes two light engines 2. In particular, one light engine 2 is configured to provide uplight while the other light engine 2 is configured to provide downlight as discussed below. Optionally, the light fixture 8 may include a lens or optic 40 that is supported on the housing 10.

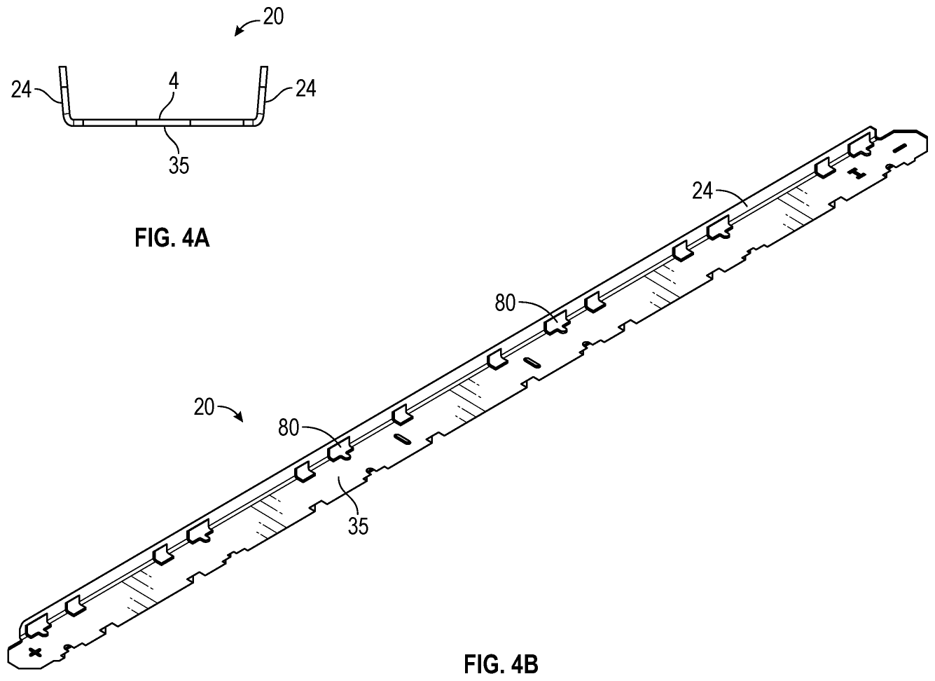

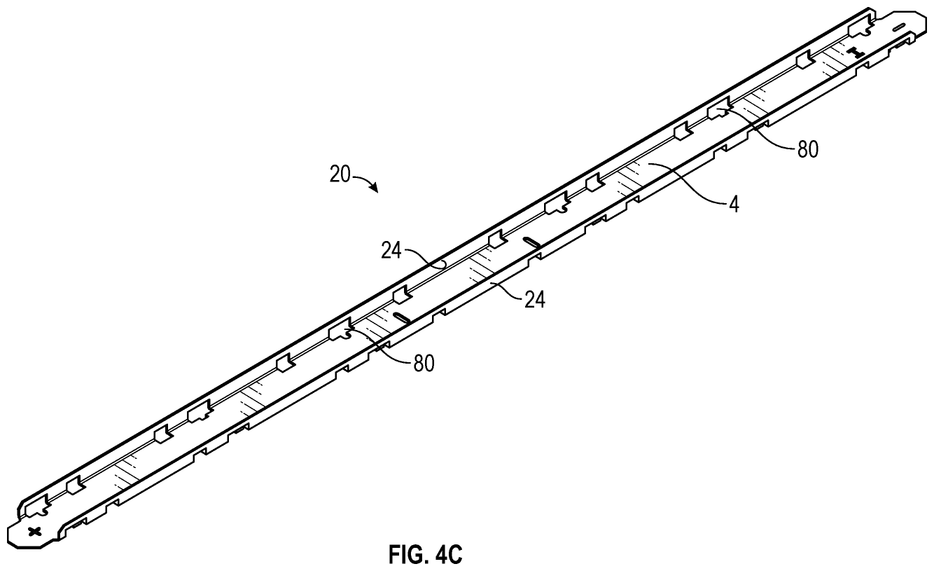

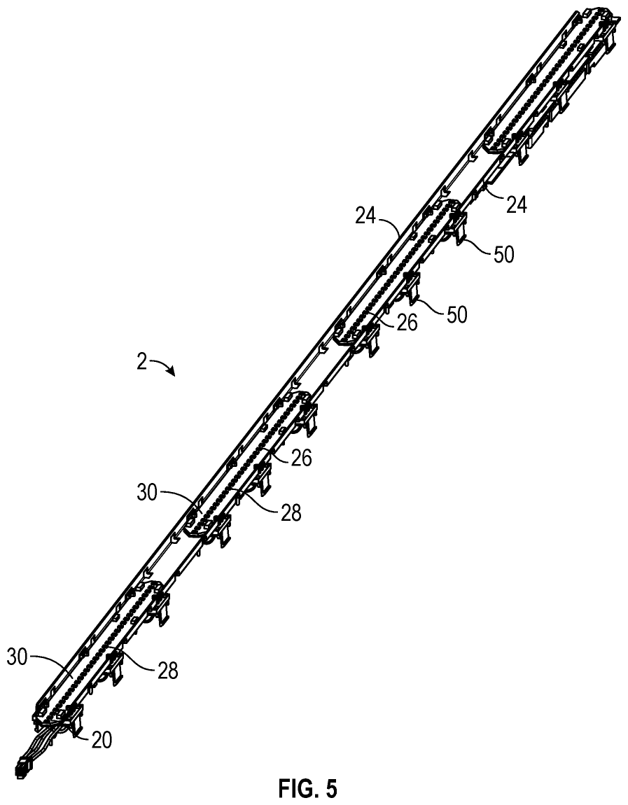

Each light engine 2 may include at least one mounting substrate 20. The mounting substrate 20 may be a board constructed from various suitable materials as desired, including but not limited to various metals and/or plastics. As seen in FIG. 4, the mounting substrate 20 includes a front surface 4 and a rear surface 35 opposite the front surface 4. In some embodiments, one or more reflector wings 24 may optionally extend downwardly from the mounting substrate 20 proximate the front surface 4 of the mounting substrate 20. In some embodiments, the reflector wings 24 may be formed separately from, and subsequently attached to, the mounting substrate 20, while in other embodiments, the reflector wings 24 may be formed integrally with the mounting substrate 20. Apertures 80 may optionally be provided in the mounting substrate 20. In certain embodiments, one or more of the apertures 80 may optionally engage mounting clips, which are discussed in greater detail below.

In certain embodiments, one or more light sources 26 may be supported on the front surface 4 of the mounting substrate 20. Optionally, at least a portion of the front surface 4 may be rendered reflective to reflect light emitted from the light sources 26 out of the light fixture 8 and/or include other optical finishes and/or have optical distribution characteristics as desired. [0001]

In some embodiments, the light sources 26 include light emitting diodes 28 (“LEDs”) mounted on a printed circuit board 30 (“PCB”) and wired to the PCB 30. Any number of PCBs 30 may be mounted on the mounting substrate 20. Each PCB 30 may have wiring for connecting to a driver, which can be shared between PCBs or each PCB may have its own power supply. The LEDs 28 may be single-die or multi-die LEDs, DC or AC, or can be organic light emitting diodes. White, color, or multicolor LEDs may be used. Moreover, the LEDs mounted on a PCB need not all be the same color; rather, mixtures of LEDs may be used. Optionally, and as discussed in detail below, one or more notches 82 may be provided along an edge or along the opposing edges of a PCB 30 that may be used to mount the PCB 30 in a particular orientation.

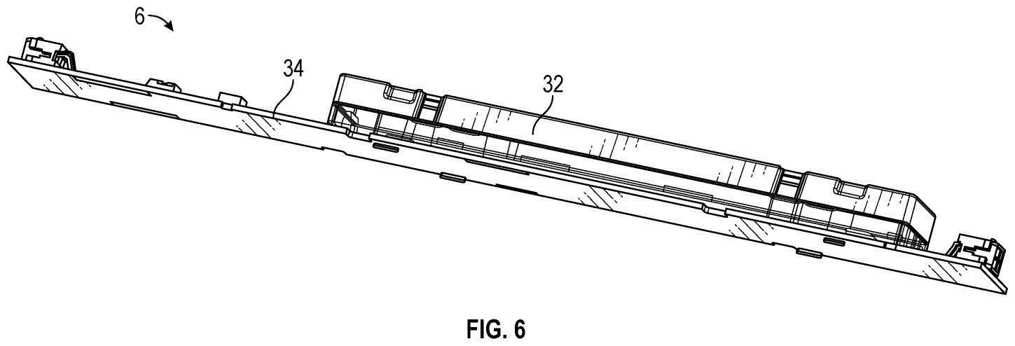

An electronics board 6 (see FIG. 6) including a mounting board 34 onto which is mounted various electronic components (generally indicated by 32) for powering and/or controlling the light sources 26 (e.g., driver(s), controller(s), etc.). The electronics board 6 may be supported on the rear surface 35 of the mounting substrate 20 opposite the PCB 30 and/or light sources 26. The particular electronics board 6 illustrated should not be considered limiting, and the electronics board 6 may have various shapes, configurations, and combinations of electronic components as desired. In certain embodiments, the electronics boar 6 may optionally include a housing constructed from metal, plastic, and/or other materials as desired.

In various embodiments, and as discussed in detail below, one or more mounting clips 50 may optionally be used both to assemble the components of the light engine 2 and mount the light engine 2 onto the housing 10.

The housing 10 of the light fixture 8 may be formed of any material having suitable structural integrity and thermal management properties. In some embodiments, the housing 10 is formed of a metallic material, such as, but not limited to, extruded aluminum.

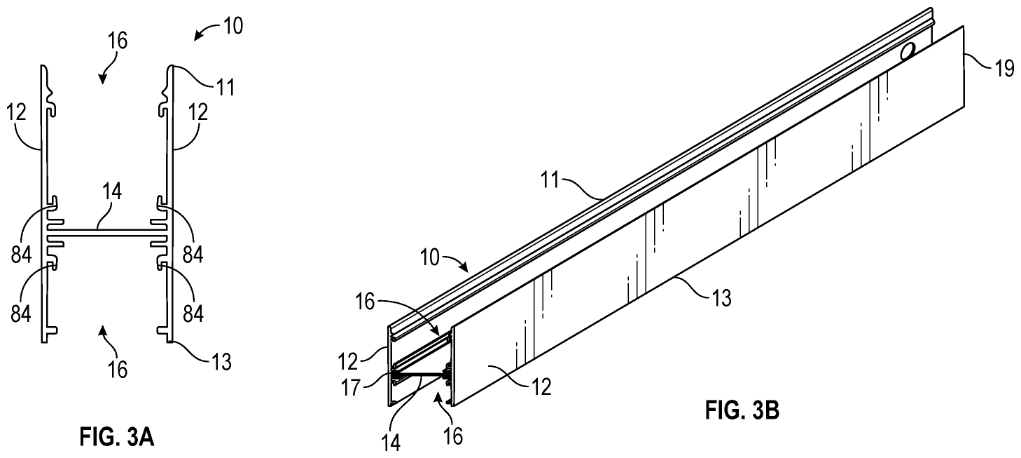

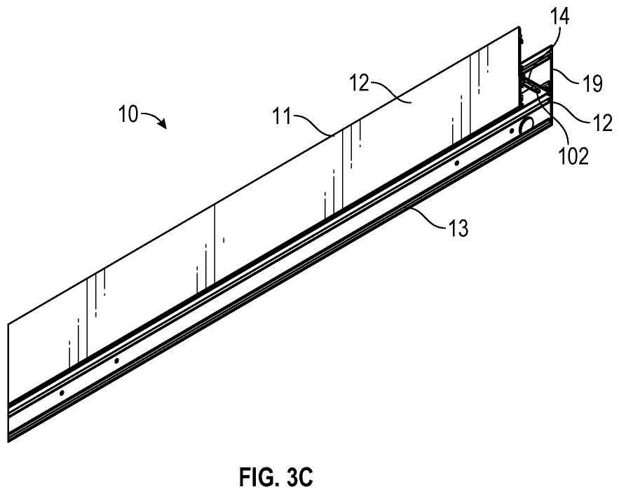

As best illustrated in FIGS. 3A-C, the housing 10 may include side walls 12 and at least one transverse wall 14 that extends between the side walls 12 so as to connect the side walls 12. In the illustrated embodiment, the transverse wall 14 is located between a top end 11 and a bottom end 13 along the height of the housing 10 such that a housing cavity 16 is formed on either side of the transverse wall 14. Such a geometry of the transverse wall 14 between the top end 11 and the bottom end 13 of the housing 10 may be particularly suitable for a light fixture such as the light fixture 8 intended to provide both downlight and uplight. As a non-limiting example, a light engine 2 may be provided in each of the housing cavities 16 (as shown in FIGS. 1 and 2) such that the light sources 26 of one light engine 2 generally emit light upwards relative to the housing 10 and the light sources 26 of the other light engine 2 generally emit light downwards relative to the housing 10. In other embodiments, the transverse wall 14 may connect the top end 11 and/or the bottom end 13 of the side walls 12 such that only one housing cavity 16 is formed in the housing 10. In these embodiments, a light engine 2 may be provided for only one of downlight or uplight.

In certain embodiments, each side wall 12 includes at least one ledge 84 that extends inwardly into at least one of the housing cavities 16 and along at least a portion of the length of the fixture housing 10.

In some embodiments, the housing 10 optionally defines an aperture 102 (see FIG. 3C). In certain cases, the aperture 102 may be provided in the transverse wall 14 proximate one or both ends 17, 19 of the housing 10, although in other embodiments the aperture 102 may be provided at other locations as desired.

End caps 36 may optionally be mounted on the ends 17, 19 of the housing 10 to restrain axial movement of the components within the housing and to impart a polished appearance to the light fixture 8. As discussed in detail below, the end caps 36 may be easily installed on the housing 10 without the use of fasteners and may be easily removed in the field to permit access to the components housed therein and then subsequently re-attached. An optic 40 may be coupled to the housing 10 so as to extend over the light sources 26 and control the appearance of light emitted from the light fixture 8.

### Light Engine Mounting Clip

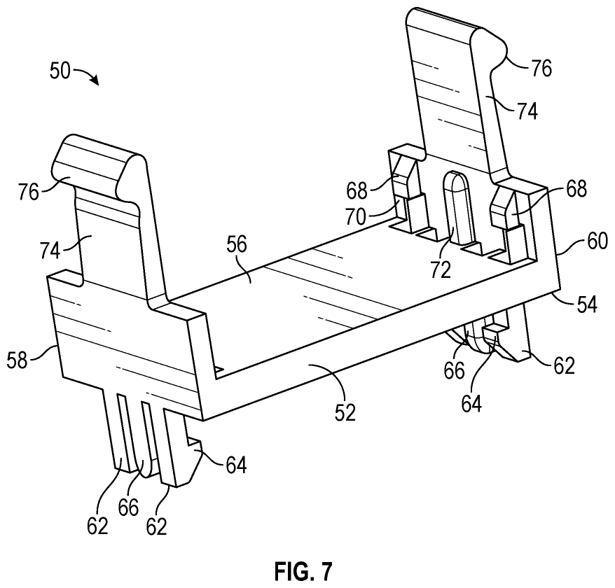

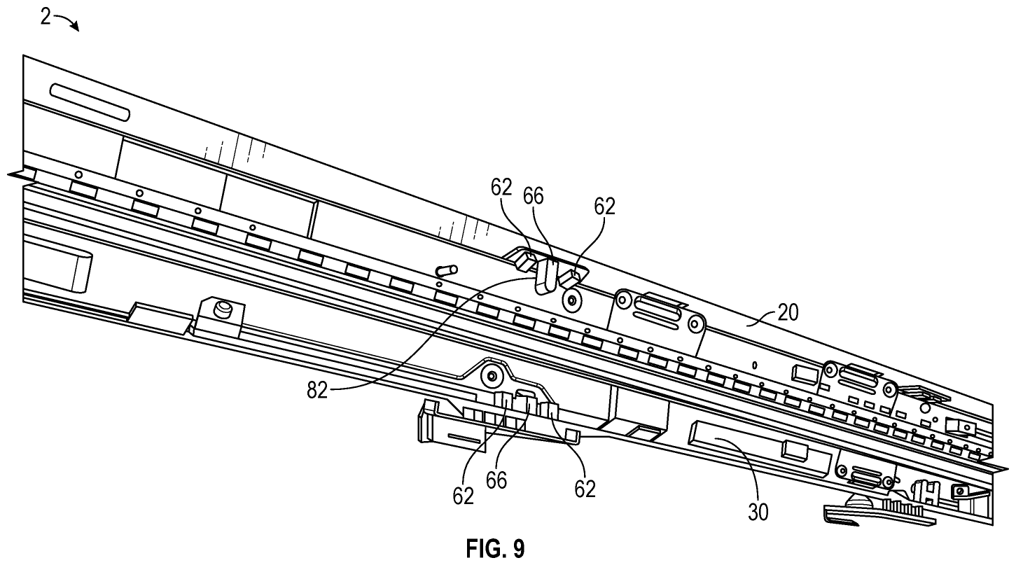

In certain embodiments, and as best illustrated in FIGS. 7-11G, a mounting clip 50 that may be used to retain the PCB 30 and electronics board 6 on the mounting substrate 20 so as to form the light engine 2. Additionally or alternatively, the mounting clip 50 may retain the light engine 2 within the housing 10. In certain embodiments, the mounting clip 50 may retain the PCB 30 and electronics board 6 on the mounting substrate 20 and/or retain the light engine 2 within the housing 10 without the need for mechanical fasteners, such as screws, bolts, etc.

As best illustrated in FIG. 7, the mounting clip 50 generally includes a central body 52 that defines a first surface or side 54, an opposing second surface or side 56, a first side edge 58 and an opposing second side edge 60. A plurality of first fingers 62 extend from the central body 52 on the first side 54 of the mounting clip 50. More specifically, at least one first finger 62 extends from the central body 52 proximate each of the first side edge 58 and the second side edge 60 of the mounting clip 50. The first fingers 62 each include a lip 64 that extends toward the center of the mounting clip 50. While only one first finger 62 need be provided proximate each side edge 58, 60 of the mounting clip 50, any number may be provided. As a non-limiting example, the mounting clip 50 illustrated in the figures includes a pair of first fingers 62 provided proximate each side edge 58, 60 in the mounting clip 50. Moreover, the same number of first fingers 62 need not be provided proximate each side edge 58, 60. Nor must the first fingers 62 be laterally aligned with each other across the mounting clip 50. As a non-limiting example, a first finger 62 extending from the first side edge 58 may be, but does not have to be, aligned with a first finger 62 extending from the second side edge 60.

One or more first alignment features 66 may optionally be provided on the first side 54 of the central body 52, the purpose of which are discussed in more detail below. While in the illustrated embodiment a first alignment feature 66 is provided on the first side 54 proximate each side edge 58, 60, in other embodiments, the mounting clip 50 may omit the first alignment features 66, may include one first alignment feature 66, or may include more than two first alignment features 66.

A plurality of second fingers 68, which may be similar to the first fingers 62, extend from the second side 56 of the central body 52. More specifically, at least one second finger 68 extends from the second side 56 proximate each of the first side edge 58 and the second side edge 60 of the central body 52. The second fingers 68 each include a lip 70 that extends toward the center of the mounting clip 50. While only one second finger 68 need be provided proximate each side edge 58, 60, any number may be provided. For example, a pair of second fingers 68 are provided proximate each side edge 58, 60 in the embodiment shown in the figures. Moreover, the same number of second fingers 68 need not be provided proximate each side edge 58, 60. Nor must the second fingers 68 be laterally aligned with each other across the mounting clip 50. As a non-limiting example, a second finger 68 extending from the first side edge 58 may be, but does not have to be, aligned with a second finger 68 extending from the second side edge 60.

One or more second alignment features 72 may optionally be provided on the mounting clip 50, the purpose of which are discussed in more detail below. While in the illustrated embodiment a second alignment feature 72 is provided on the second side 56 of the central body 52 proximate each side edge 58, 60, in other embodiments the mounting clip 50 may omit the second alignment feature 72, may include one second alignment feature 72, or may include more than two second alignment feature 72.

Opposing attachment arms 74 also extend from the second side 56 of the central body proximate the opposing side edges 58, 60. In certain embodiments, the attachment arms 74 extend beyond the second fingers 68. Each attachment arm 74 includes a lip 76 that extends outwardly from the center of the mounting clip 50. While two attachment arms 74 are illustrated, in other embodiments, any number of attachment arms 74 may extend from the clip proximate each side of the mounting clip 50 as desired.

The mounting clip 50 may be formed of any material, including, but not limited to, metal and polymeric materials. In various embodiments, the various components of the mounting clip 50 may be formed separately and subsequently assembled, while in other embodiments, the mounting clip 50 is formed integrally. For example, the mounting clip 50 could be formed of a molded polymeric material.

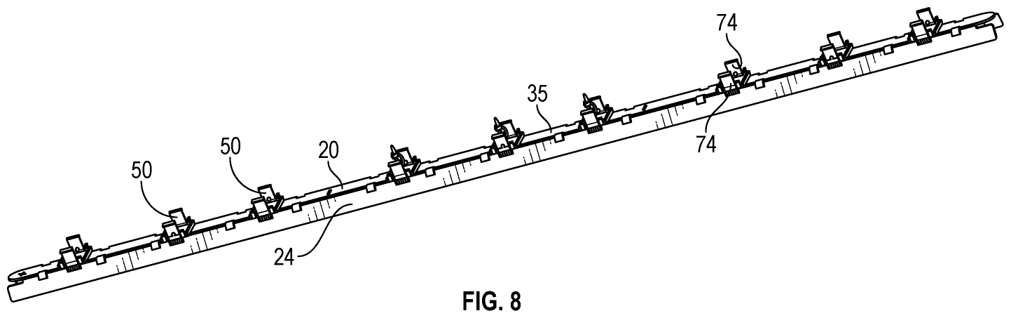

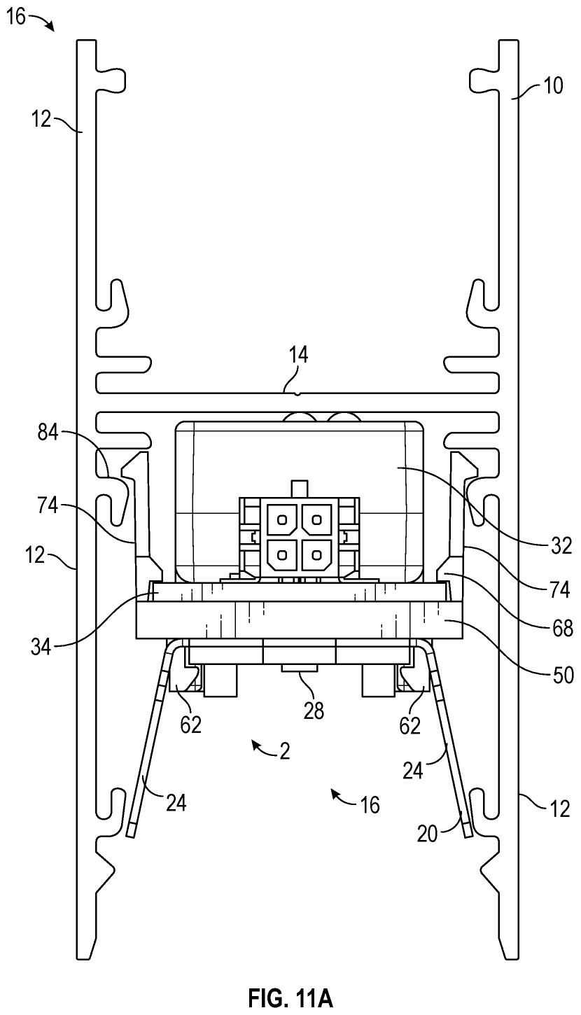

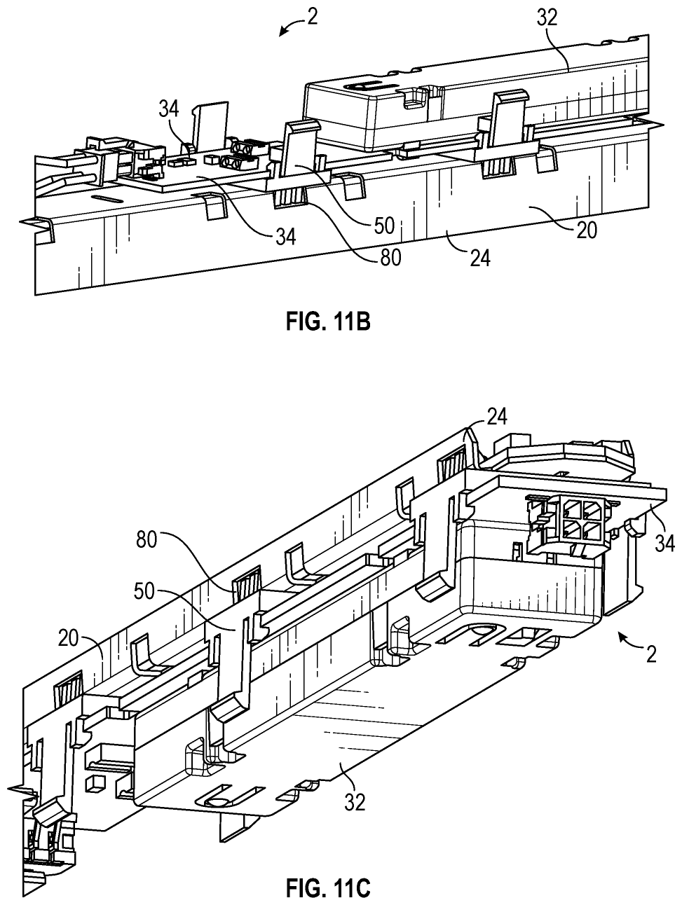

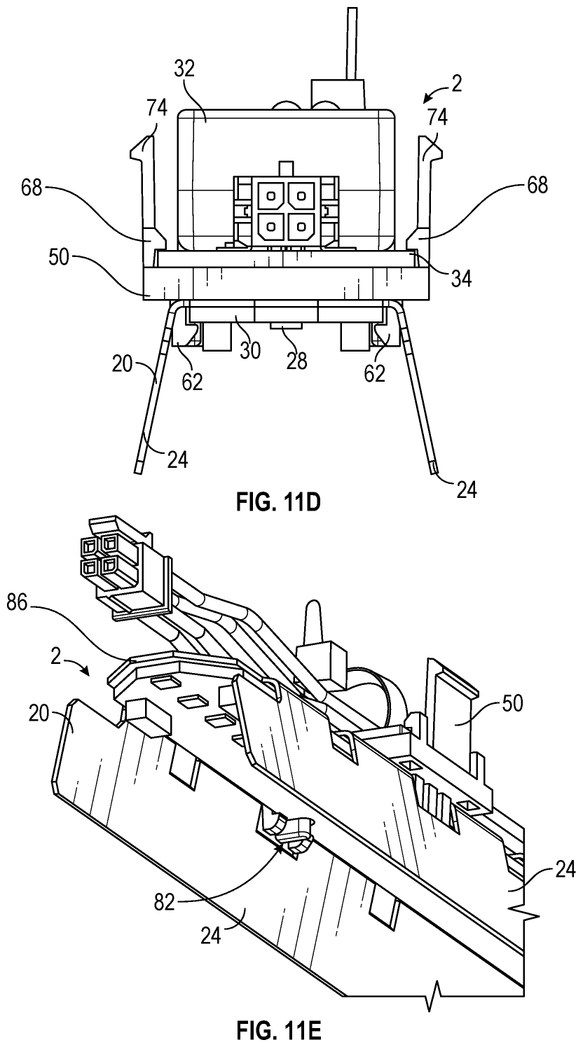

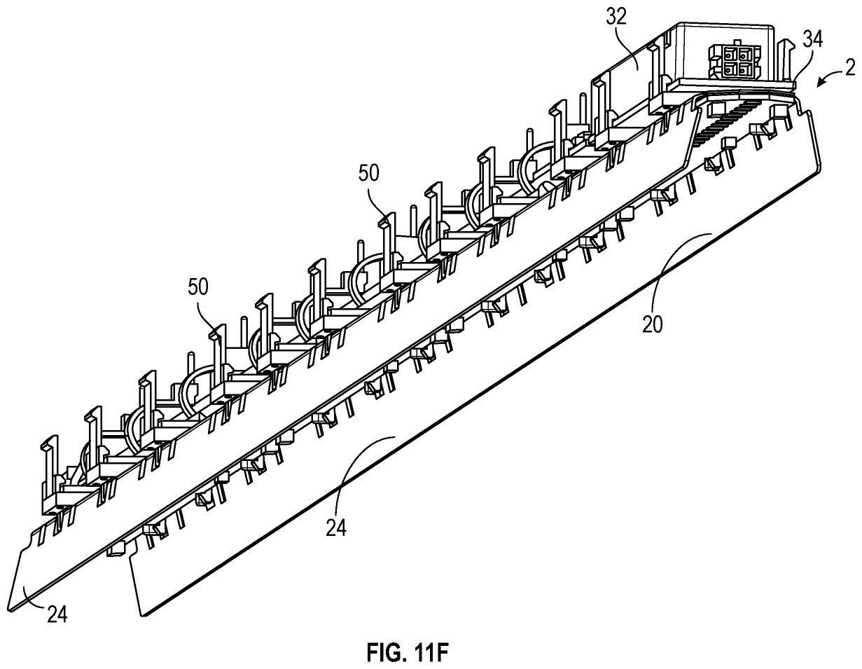

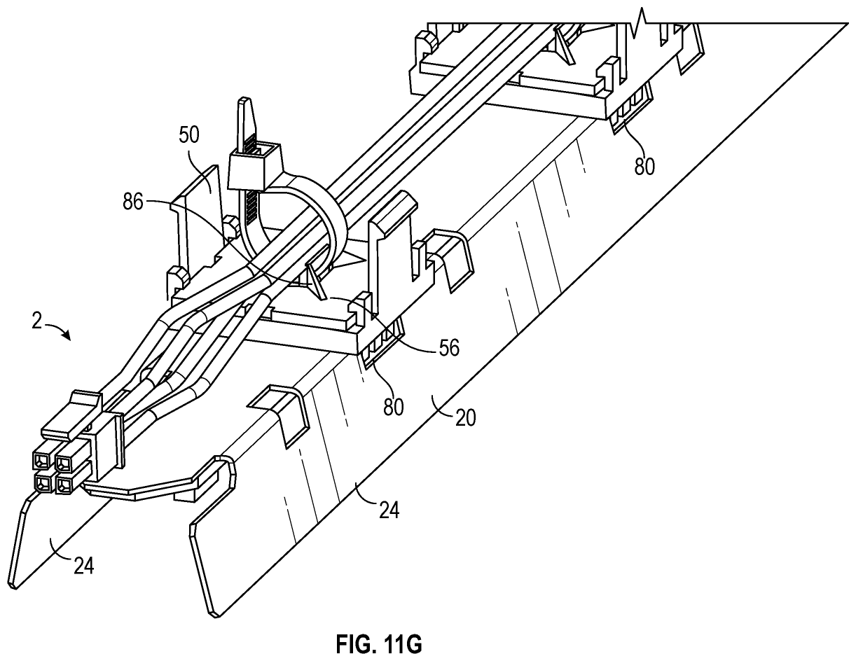

As best illustrated in FIGS. 8 and 11A-G, the mounting clip 50 may be assembled with the mounting substrate 20 such that the first side 54 of the mounting clip 50 is proximate the rear surface 35 of the mounting substrate 20. As best illustrated in FIGS. 11A-G, the first fingers 62 and first alignment features 66 may extend through the apertures 80 in the mounting substrate 20 so as to be exposed on the front surface 4 of the mounting substrate 20.

A PCB 30 may be assembled with the mounting substrate 20 via the mounting clip 50. In particular, the PCB 30 may be pressed downwardly toward the front surface 4 of the mounting substrate 20 such that the PCB 30 engages the first fingers 62, thereby causing the fingers 62 to deflect outwardly so as to permit the opposing edges of the PCB 30 to clear the first fingers 62. Once cleared, the first fingers 62 snap back and the edges of the PCB 30 are trapped between the lip 64 of each first finger 62 and the front surface 4 of the mounting substrate 20. In this way, the PCB 30 is retained on the front surface 4 of the mounting substrate 20.

In embodiments where the PCB includes the notch(es) 82, the first alignment features 66 of the mounting clip 50 may be sized and shaped to fit within the notches 82 on the PCB 30. The mounting locations of the clips 50 on the mounting substrate 20 as well as the first alignment features 66 may ensure that the PCBs 30 can only engage the clips 50 when oriented in the proper rotational orientation. More specifically, the notches 82 on the PCBs 30 and the first alignment features 66 will only align so as to permit the PCB 30 to clear the first fingers 62 and seat on the mounting substrate 20 when the PCBs 30 are oriented as desired. In this way, the first alignment features 66 on the clips 50 may locate and require a correct orientation of the PCB 30 on the mounting substrate 20.

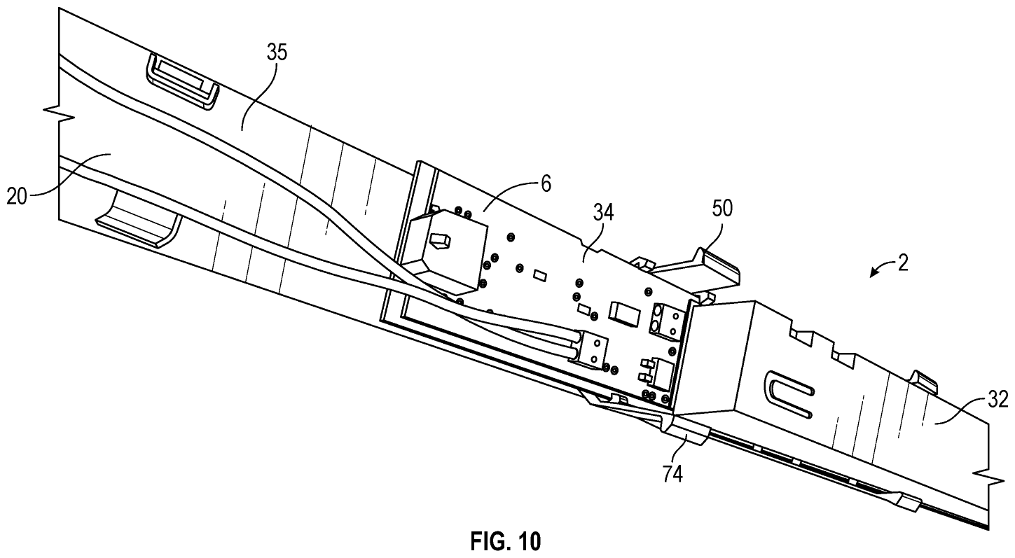

The electronics board 6 may be mounted to the mounting substrate 20 in the same manner as the PCBs 30, but with the second fingers 68 and/or alignment features 72 provided on the opposing side of the mounting clip 50. FIGS. 10 and 11A-G illustrate the second fingers 68 overlapping and trapping edges of the electronics board 6 between the lip 70 of each second finger 68 and the mounting clip 50. While not visible, the electronics board 6 may optionally include notches or other suitable features that selectively engage the second alignment features 72 to locate and orient the electronics board 6 relative to the mounting substrate 20. Any number of mounting clips 50 may be used to secure the lights sources 26 and electronics board 6 to the mounting substrate 20.

Once assembled, the light engine 2 may then be mounted to the fixture housing 10. Referring to FIG. 11A, in some embodiments, the light engine 2 is inserted into one of the housing cavities 16 until the attachment arms 74 of the clips 50 engage the opposing ledges 84 on the side walls 12. The ledges 84 may ride along the ramped surfaces of the attachment arms 74 as the light engine 2 is inserted, thereby causing the attachment arms 74 to deflect inwardly. Once attachment arms 74 have cleared the ledges 84, they may return to their equilibrium state. The lip 76 on each attachment arm 74 abuts the ledge 84 (e.g., by overlapping the ledge 84 or as otherwise desired), which may prevent the light engine 2 from becoming inadvertently disengaged from the housing 10.

As illustrated, the mounting clip 50 thus replaces all mechanical fasteners that have typically been required to retain the components on the light engine 2 and that have been required to retain the light engine 2 within the housing 10. In addition to mounting the features of the light engine 2 and mounting the light engine 2 with the housing 10, the mounting clip 50 may also accommodate auxiliary components for the light fixture. As a non-limiting example, FIGS. 11E and 11G illustrate a wireway management board 86 snap-fit onto the second side 56 of the mounting clip 50 to route wires associated with the electronic components 32 on the electronics board 6.

### End Cap

As mentioned, in certain embodiments, the light fixture 8 may include one or more end caps 36. In various embodiments, the end caps 36 may be easily installed on the housing 10 without the use of fasteners. The end caps 36 may also be easily removed from the housing 10 in the field to permit access to the components housed within the housing 10 (and then subsequently re-attached to the housing 10). In some embodiments, an end cap 36 may be snap-fit onto an end of the housing 10, although other features and/or mechanisms may be used to selectively attach the end cap 36 with the housing 10.

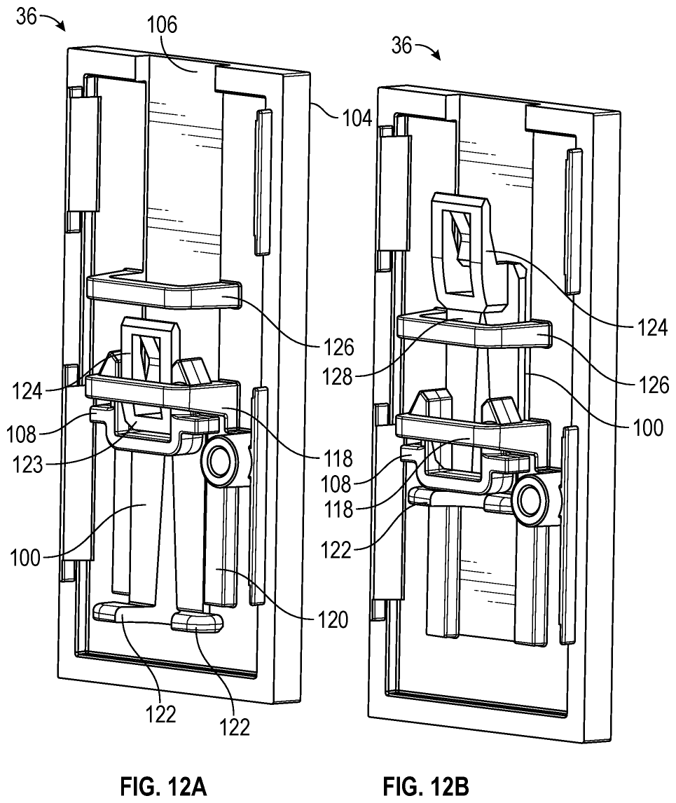

In various embodiments, and as illustrated in FIGS. 12A-15B, the end cap 36 may include a translating lever 100 that can selectively engage and disengage the aperture 102 in the housing 10 to retain the end cap 36 on the housing 10 and permit its easy removal. More specifically, and as best illustrated in FIGS. 12A-B, the end cap 36 includes an outer side 104 and an inner side 106. The outer side 104 may be exposed on the housing 10 when the end cap 36 is installed to impart a polished appearance to the light fixture 8, and the inner side 106 may face and/or abut the end of the housing 10 when the end cap 36 is installed. The lever 100 may be retained on the inner side 106 of the end cap 36 and may be configured to translate along an axis. In some embodiments, the lever axis is substantially perpendicular to the axis of the housing 10, but need not be in all embodiments.

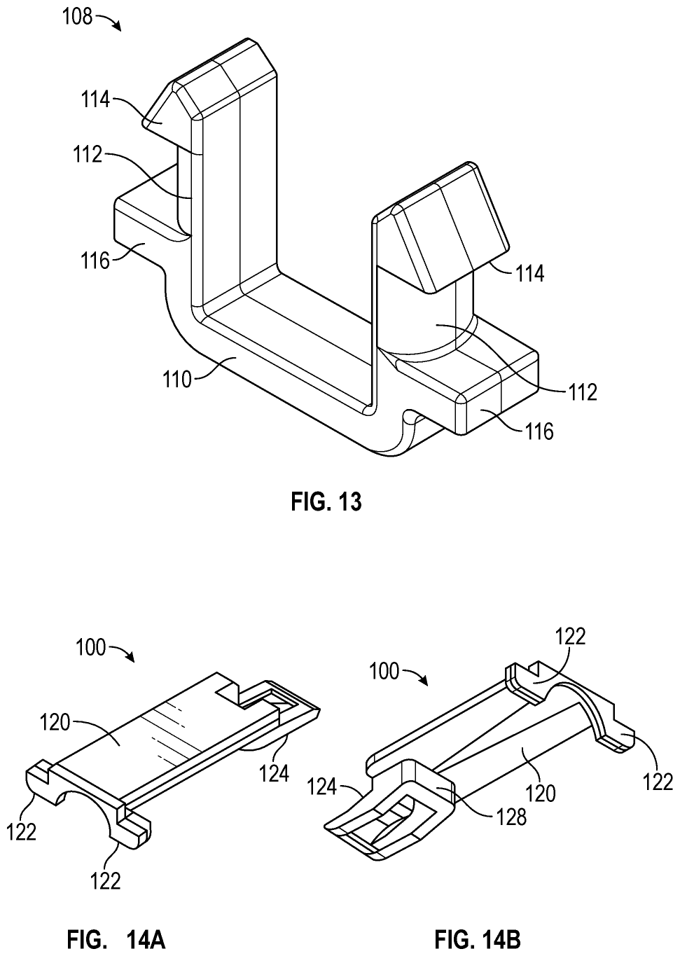

The lever 100 may be retained on the end cap 36 with a lever lock 108. In certain embodiments, the lever lock 108 may also serve to limit the range of motion of the lever 100 on the end cap 36 (as described in more detail below). In some embodiments, and as best illustrated in FIG. 13, the lever lock 108 may include a generally U-shaped body having a central portion 110 with a wing 112 that extends from the central portion 110 proximate each side of the central portion 110. A lip 114 may extend outwardly proximate the distal end of each wing 112, and a ledge 116 may extend outwardly from each wing 112 between the central portion 110 and the lip 114.

As best illustrated in FIGS. 12A-B, a first bridge 118 extends from the inner side 106 of the end cap 36, and the lever lock 108 engages the first bridge 118. More specifically, the lever lock 108 may be snap-fitted onto the first bridge 118 such that the first bridge 118 is trapped between the lip 114 of each wing 112 and the ledge 116 of each wing 112. In this way, the lever lock 108 may be retained on the end cap 36, and its position may be locked in place relative to the end cap 36. A second bridge 126 may be, but does not have to be, provided to guide the lever 100 during its translation relative to the end cap 36, as discussed below.

As best illustrated in FIGS. 14A-B, the lever 100 includes an elongated lever body 120, at least one stop 122 (two are illustrated) extending from the lever body 120, and an engagement arm 124 extending from the lever body 120. The stop(s) 122 and the engagement arm 124 may be provided at a predetermined distance from each other on the lever body 120. The lever 100 is positioned on the end cap 36 such that the first bridge 118 and lever lock 108 at least partially overlap the lever body 120. In certain embodiments, the lever 100 is positioned on the end cap 36 such that the central portion 110 of the lever lock 108 is between the stop 122 and the engagement arm 124. When assembled on the end cap 36, the lever 100 is movable between a first position (FIG. 12A) and a second position (FIG. 12B). In the first position, the central portion 110 of the lever lock 108 may contact and/or otherwise engage the engagement arm 124, and in the second position, the central portion 110 of the lever lock 108 may contact and/or otherwise engage the stop(s) 122. Abutment of a ledge 128 of the engagement arm 124 with the central portion 110 of the lever lock 108 in the first position may prevent the lever 100 from backing out of the first bridge 118 and disengaging from the end cap 36. Likewise, abutment of the stop(s) 122 with the central portion 110 in the second position may prevent the lever 100 from passing entirely through the first bridge 118 and disengaging from the end cap 36. In this way, the lever 100 may be retained on the end cap 36 while also being movable relative to the end cap 36.

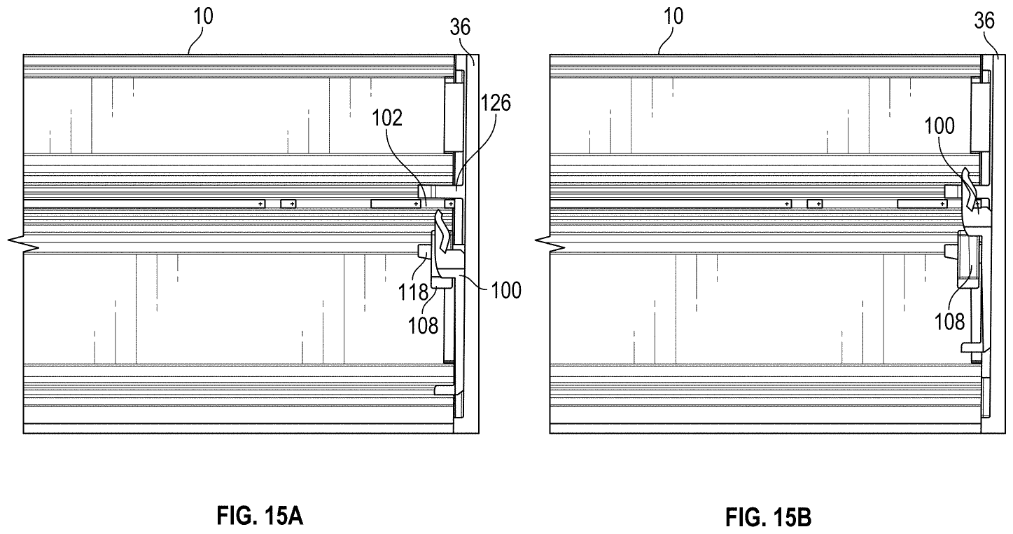

Referring to FIGS. 15A-B, to install the end cap 36 on the housing 10, the end cap 36 is positioned an end 17, 19 of the housing 10, and the lever 100 translated from the first position to the second position such that the engagement arm 124 of the lever 100 engages the aperture 102 in the housing 10. In various embodiments, the abutment of the stop(s) 122 of the lever 100 with the central portion 110 of the lever lock 108 may audibly and/or physically alert the installer that the lever 100 has been moved sufficiently to engage the aperture 102. To remove an installed end cap 36, the optic 40 (if present) may be removed from the housing 10 such that the installer can access the lever 100 on the inner side 106 of the end cap 36. The lever 100 is slid from the second position to the first position such that the engagement arm 124 of the lever 100 disengages the aperture 102 in the fixture housing 10.

### Mounting Brackets

Other embodiments of the invention relate to a mounting system for retention of light fixtures within a ceiling or wall. Such a mounting system may be useful in recessed installations whereby an aperture is provided in the ceiling or wall surface for receiving a light fixture, such as the light fixture 8.

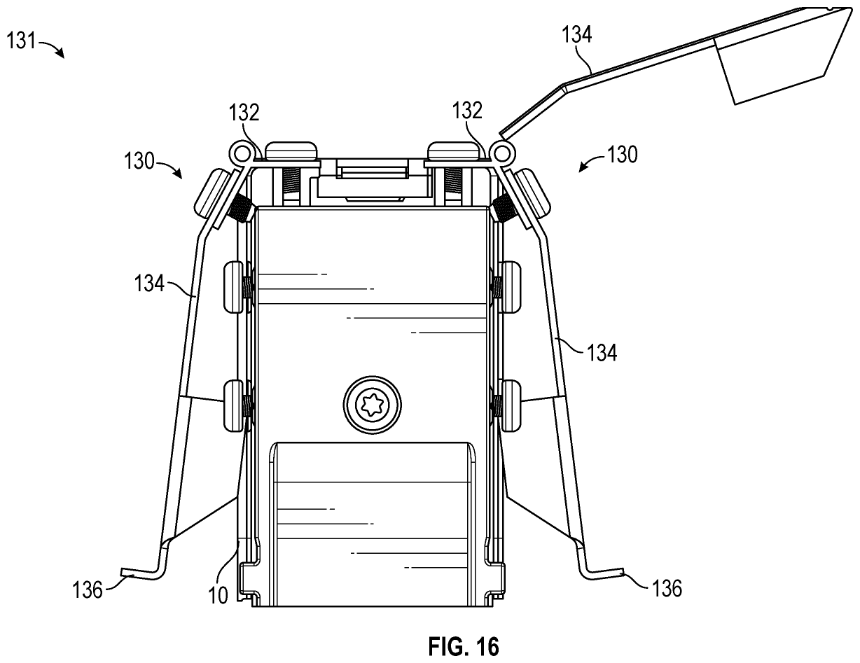

Referring to FIGS. 16-18C, in some embodiments, a mounting system 131 includes a mounting bracket 130, and the mounting bracket 130 includes a mounting plate 132 and a retention wing 134 that is pivotably engaged with and supported on the mounting plate 132. The retention wing 134 may be adjusted from a first rotational position in which the retention wing 134 extends substantially vertically upwardly from the mounting plate 132 to a second rotational position in which the retention wing 134 is angled downwardly from mounting plate 132. In FIG. 16, the left wing 134 is illustrated in the second rotational position, and the right wing 134 is illustrated moving from the second rotational position to the first rotational position. In certain embodiments, the wings 134 may be biased toward the second rotational position. One or more feet 136 may optionally extend from the retention wings 134 for engagement with the inner surface of a ceiling or wall, as discussed in more detail below.

One or more apertures extend through the mounting plate 132 for receiving one or more fasteners that attach the mounting plate 132 to the fixture housing 10. In some embodiments, apertures are provided in the housing 10 for receiving the fasteners. In such embodiments, the location of the mounting brackets 130 on the housing 10 is fixed (i.e., the mounting brackets 130 must be attached to the housing 10 at predetermined locations dictated by the location of the fastener apertures in the housing 10).

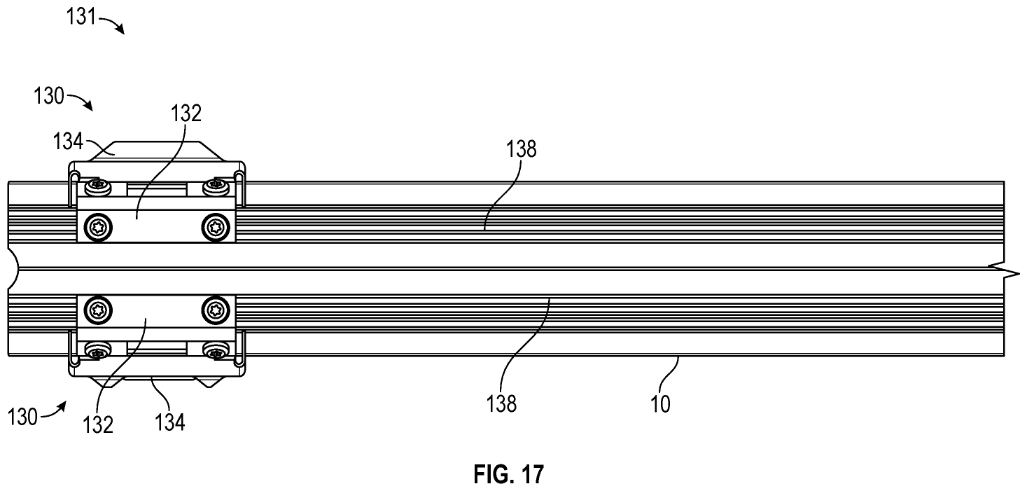

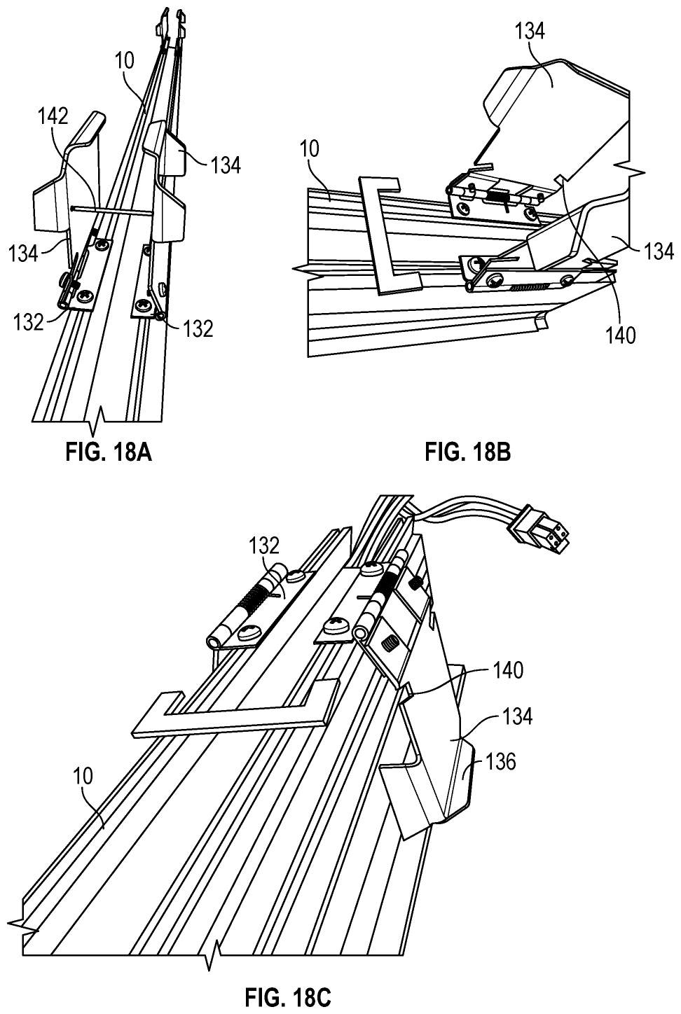

In an alternative embodiment, and as illustrated in FIGS. 17 and 18, one or more channels 138 are formed in or otherwise provided on a rear portion of the housing 10. While two channels 138 are formed in the housing 10 of FIGS. 17 and 18, fewer or more channels may be used. Moreover, channels 138 may extend the entire length of the housing 10 (which would impart maximum versatility as the mounting brackets 130 could then be installed at any location along the length of the light fixture 8) or may extend along only a portion of the length of the housing 10. The fasteners on the mounting plate 132 engage the channels 138 to retain the mounting bracket 130 on the housing 10. In this way, the mounting brackets 130 may be installed on the housing 10 at any location along a channel 138. Moreover, the location of the mounting brackets 130 is easily adjusted at any time as desired. Any number of mounting brackets 130 may be used to install a light fixture 8. While aligned pairs of mounting brackets 130 may be installed at a location along the fixture length, in other embodiments the mounting brackets 130 are provided in a staggered orientation along the length of the housing 10.

To install a light fixture 8, the desired number of mounting brackets 130 are installed on the housing 10 at the desired locations (e.g., via apertures, channels 138, and/or as otherwise desired). The retention wings 134 are pivoted upwardly so as to be oriented in the first rotational orientation so as to permit the light fixture 8 to be passed at least partially though the wall or ceiling aperture. Engagement between the retention wings 134 and the aperture wall or ceiling edges may help retain the retention wings 134 in the first rotational orientation. Once the retention wings 134 have cleared the aperture, the bias in the retention wings 134 causes them to pivot to the second rotational orientation so as to contact the inner surface of the ceiling or wall. The feet 136 (if present) on the retention wings 134 may engage the inner surface to stabilize the retention wings 134 relative to the inner wall or ceiling surface.

In embodiments where aligned pairs of mounting brackets 130 are mounted on a housing 10, one or more notches or grooves 140 may optionally be provided along an edge of the retention wing 134 of each mounting bracket 130. In these embodiments, the grooves 140 may align when the retention wings 134 are in the first rotational orientation. A locking bar 142 may optionally be positioned in the grooves 140 so as to extend between the retention wings 134. The locking bar 142 retains the retention wings 134 in the first rotational orientation for insertion through the wall or ceiling aperture. In some embodiments, the grooves 140 are positioned along a side edge of the retention wing 134 and oriented such that the groove axis extends at a downward angle toward the housing 10 when in the first rotational orientation. The downward orientation in these embodiments may assist in releasing the locking bar 142 from the grooves 140 after the light fixture 8 has been inserted into the opening. More specifically, in some embodiments, when the light fixture 8 is inserted into the opening, the edges of the opening apply a force onto the opposing retention wings 134, forcing them to move slightly towards each other. This movement may help to release the locking bar 142 from the grooves 140.

### Alignment System

Other embodiments of the present invention relate to an alignment system that permits easy linear alignment and connection of adjacent light fixtures within an aperture. Adjacent linear light fixtures have typically been aligned and joined by bringing them together along an axis parallel to the axis of the linear fixtures. This method is not possible when the adjacent fixtures need to be aligned and joined within a pre-existing ceiling or wall aperture.

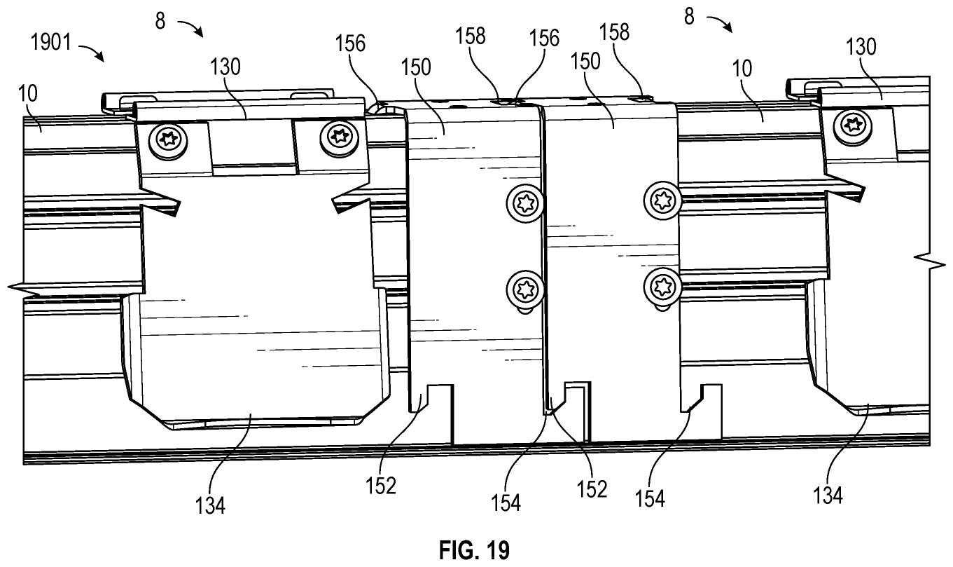

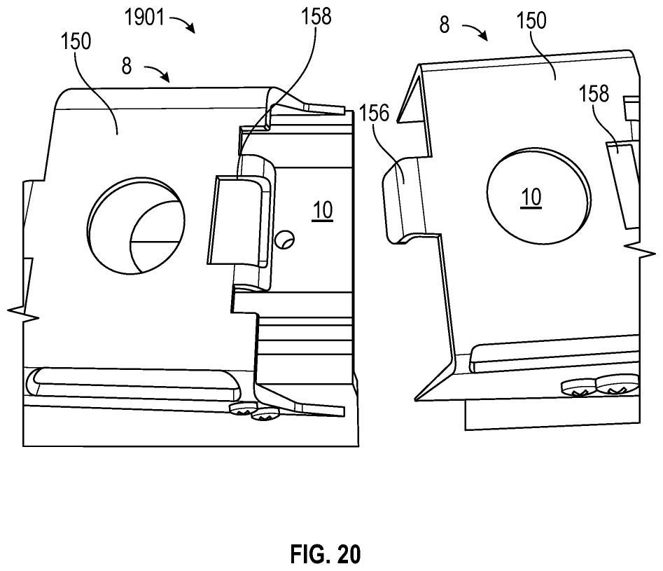

FIGS. 19 and 20 illustrate an alignment system 1901 that permits linear alignment and joining of adjacent light fixtures 8 in a direction substantially perpendicular to the linear axis of the fixtures. The alignment system 1901 includes an alignment bracket 150 provided on at least one side wall 12 of the housing 10 at an end 17, 19 of the housing 10. In some embodiments, an alignment bracket 150 is provided on each side wall 12 of the housing 10. In the illustrated embodiment, the alignment bracket 150 is a U-shaped bracket formed as a single piece (metal or plastic). In this embodiment, each arm of the U-shaped bracket is mounted to a side wall 12 of the housing 10.

The alignment brackets 150 include at least one nesting feature for engagement with a complementary nesting feature on the alignment bracket 150 on an adjacent fixture housing 10. In the embodiment of FIG. 19, the complementary nesting features are a hook 152 and a groove 154, whereby the adjacent light fixtures 8 are aligned and connected by engagement of the hook 152 in the groove 154. However, the nesting features could have geometries other than those illustrated herein.

As best illustrated in FIG. 20, in certain embodiments the alignment bracket 150 includes a locking feature for helping to ensure adjacent light fixtures 8 remain aligned and connected. In the embodiment of FIG. 20, the locking feature includes a tab 156 that extends downwardly from the top of the U-shaped alignment bracket 150 and that engages a slot 158 in top of the adjacent alignment bracket 150. When the adjacent fixtures 8 are aligned, the tab 156 engages the slot 158 to help prevent relative linear movement between the fixtures 8. Other types of locking features may be utilized as desired.

In certain embodiments, both nesting features (e.g., hook 152 and groove 154) and locking features (e.g., tab 156 and slot 158) may be provided on opposing sides of an alignment bracket 150 such that each alignment bracket 150 is universal and thus can be positioned on either end 17, 19 of the housing 10.

A collection of exemplary embodiments are provided below, including at least some explicitly enumerated as “Illustrations” providing additional description of a variety of example embodiments in accordance with the concepts described herein. These illustrations are not meant to be mutually exclusive, exhaustive, or restrictive; and the disclosure not limited to these example illustrations but rather encompasses all possible modifications and variations within the scope of the issued claims and their equivalents.

Illustration 1. A light fixture comprising: a light engine comprising: a mounting substrate comprising a front surface, a rear surface opposite the front surface, and at least one aperture extending through the mounting substrate; at least one light source; and at least one electronics board; and a mounting clip comprising: a central body comprising a first surface, a second surface opposite the first surface, a first side edge, and a second side edge opposite the first side edge; at least one first finger extending from the first surface; and at least one second finger extending from the second surface, wherein the at least one first finger extends through the at least one aperture of the mounting substrate and retains the at least one light source on the front surface of the mounting substrate, and wherein the at least one second finger retains the at least one electronics board on the second surface of the mounting clip.

Illustration 2. The light fixture of any preceding or subsequent illustrations or combination of illustrations, further comprising a fixture housing comprising a pair of side walls defining a housing cavity, wherein each side wall comprises a ledge extending into the housing cavity, wherein the mounting clip further comprises a plurality of attachment arms extending from the second surface, and wherein the plurality of attachment arms engage the ledges of the side walls of the housing such that the light engine is attached to the housing via the mounting clip.

Illustration 3. The light fixture of any preceding or subsequent illustrations or combination of illustrations, further comprising: a fixture housing comprising a pair of side walls and a transverse wall extending between the side walls, wherein the side walls and transverse wall extend between a first end and a second end of the fixture housing, wherein the side walls and transverse wall define a housing cavity, wherein the transverse wall defines an aperture proximate to the first end of the housing, and wherein the light engine is mounted on the fixture housing via the mounting clip; and an end cap removably mounted to the first end of the fixture housing, wherein the end cap comprises an inner side, an outer side, a lever lock supported on the inner side, and a lever retained on the end cap via the lever lock, wherein the lever is movable along an axis between a first position and a second position, wherein, in the first position, the lever is engaged with the aperture of the fixture housing, and wherein, in the second position, the lever is disengaged from the aperture of the fixture housing.

Illustration 4. The light fixture of any preceding or subsequent illustrations or combination of illustrations wherein the end cap further comprises a first bridge on the inner side, wherein the lever lock is connected to the first bridge and comprises a central portion, wherein the lever comprises a stop and an engagement arm opposite from the stop, and wherein the lever is retained on the end such that the central portion of the lever lock is between the stop and the engagement arm.

Illustration 5. The light fixture of any preceding or subsequent illustrations or combination of illustrations, wherein the mounting clip further comprises a first alignment feature extending from the first surface, wherein the mounting substrate comprises at least one notch, and wherein the first alignment feature is configured to engage the at least one notch of the mounting substrate.

Illustration 6. The light fixture of any preceding or subsequent illustrations or combination of illustrations, wherein the at least one light source comprises a printed circuit board and a plurality of light emitting diodes, wherein the at least one first finger comprises a lip extending inwards, and wherein the lip of the at least one first finger overlaps the printed circuit board such that the at least one light source is retained on the front surface of the mounting substrate.

Illustration 7. The light fixture of any preceding or subsequent illustrations or combination of illustrations, wherein the at least one first finger comprises a lip extending inwards, wherein the at least one second finger comprises a lip extending inwards, wherein the mounting clip further comprises an attachment arm extending from the second surface, and wherein the attachment arm comprises a lip extending outwards.

Illustration 8. A light fixture comprising: a light engine; a fixture housing comprising a pair of side walls defining a housing cavity, wherein each side wall comprises a ledge extending into the housing cavity; and a mounting clip comprising: a central body comprising a first surface, a second surface opposite the first surface, a first side edge, and a second side edge opposite the first side edge; at least one first finger extending from the first surface; and a plurality of attachment arms extending from the second surface, wherein the at least one first finger is engaged with the light engine and wherein the plurality of attachment arms engage the ledges of the side walls of the housing such that the light engine is attached to the housing via the mounting clip.

Illustration 9. The light fixture of any preceding or subsequent illustrations or combination of illustrations, wherein the mounting clip further comprises at least one second finger extending from the second surface, wherein the light engine comprises: a mounting substrate comprising a front surface, a rear surface opposite the front surface, and at least one aperture extending through the mounting substrate; at least one light source; and at least one electronics board, wherein the at least one first finger engages the at least one light source and retains the at least one light source on the front surface of the mounting substrate, and wherein the at least one second finger engages the at electronics board.

Illustration 10. The light fixture of any preceding or subsequent illustrations or combination of illustrations, wherein the mounting substrate further comprises a pair of reflector wings extending from the front surface of the mounting substrate, and wherein the at least one light source is retained on the mounting substrate between the reflector wings.

Illustration 11. The light fixture of any preceding or subsequent illustrations or combination of illustrations, further comprising a mounting system comprising at least one mounting bracket, wherein the at least one mounting bracket comprises a mounting plate and a retention wing, and wherein the retention wing is pivotably connected to the mounting plate is movable between a first rotational position, in which the retention wing extends upwardly from the mounting plate, and a second rotational position, in which the retention wing extends downwardly from mounting plate.

Illustration 12. The light fixture of any preceding or subsequent illustrations or combination of illustrations, wherein the housing comprises at least one channel, wherein the mounting plate of the at least one mounting bracket is connected to the housing via the at least one channel, and wherein the mounting plate is movable along the at least one channel.

Illustration 13. The light fixture of any preceding or subsequent illustrations or combination of illustrations, wherein the fixture housing further comprises a transverse wall extending between the side walls, and wherein the light fixture further comprises: an end cap removably mounted to an end of the fixture housing, wherein the end cap comprises an inner side, an outer side, a lever lock supported on the inner side, and a lever retained on the end cap via the lever lock, wherein the lever is movable along an axis between a first position and a second position, wherein, in the first position, the lever is engaged with the transverse wall of the fixture housing, and wherein, in the second position, the lever is disengaged from the transverse wall of the fixture housing.

Illustration 14. The light fixture of any preceding or subsequent illustrations or combination of illustrations 8, wherein the mounting clip further comprises a first alignment feature extending from the first surface and a second alignment feature extending from the second surface, wherein the first alignment feature is configured to engage an electronics board of the light engine and wherein the second alignment feature is configured to engage a light source of the light engine.

Illustration 15. A light fixture comprising: a fixture housing comprising a pair of side walls and a transverse wall extending between the side walls, wherein the side walls and transverse wall extend between a first end and a second end of the fixture housing, wherein the side walls and transverse wall define a housing cavity, and wherein the transverse wall defines an aperture proximate to the first end of the housing; and an end cap removably mounted to the first end of the fixture housing, wherein the end cap comprises an inner side, an outer side, a lever lock supported on the inner side, and a lever retained on the end cap via the lever lock, wherein the lever is movable along an axis between a first position and a second position, wherein, in the first position, the lever is engaged with the aperture of the fixture housing, and wherein, in the second position, the lever is disengaged from the aperture of the fixture housing.

Illustration 16. The light fixture of any preceding or subsequent illustrations or combination of illustrations, further comprising a mounting system comprising at least one mounting bracket, wherein the at least one mounting bracket comprises a mounting plate and a retention wing, and wherein the retention wing is pivotably connected to the mounting plate is movable between a first rotational position, in which the retention wing extends upwardly from the mounting plate, and a second rotational position, in which the retention wing extends downwardly from mounting plate.

Illustration 17. The light fixture of any preceding or subsequent illustrations or combination of illustrations, wherein the mounting system further comprises an alignment bracket at the second end of the fixture housing, and wherein the alignment feature comprises at least one of a nesting feature or a locking feature configured to engage an adjacent fixture housing.

Illustration 18. The light fixture of any preceding or subsequent illustrations or combination of illustrations, wherein the end cap further comprises a first bridge on the inner side, wherein the lever lock is connected to the first bridge and comprises a central portion, wherein the lever comprises a stop and an engagement arm opposite from the stop, and wherein the lever is retained on the end such that the central portion of the lever lock is between the stop and the engagement arm.

Illustration 19. The light fixture of any preceding or subsequent illustrations or combination of illustrations, wherein the end cap further comprises a second bridge, wherein, in the first position, the second bridge at least partially covers the lever, and wherein, in the second position, the lever is spaced apart from the second bridge.

Illustration 20. The light fixture of any preceding or subsequent illustrations or combination of illustrations, further comprising: a light engine comprising at least one light source and at least one electronics board; and a mounting clip comprising: a central body comprising a first surface, a second surface opposite the first surface, a first side edge, and a second side edge opposite the first side edge; at least one first finger extending from the first surface; at least one second finger extending from the second surface; and a plurality of attachment arms extending from the second surface, wherein the at least one first finger engages the at least one light source, wherein the at least one second finger engages the at least one electronics board, and wherein the plurality of attachment arms engage the side walls of the housing.

Illustration 21. A light fixture comprising: a fixture housing comprising a pair of side walls and a transverse wall extending between the side walls, wherein the side walls and transverse wall extend between a first end and a second end of the fixture housing, and wherein the side walls and transverse wall define a housing cavity; and a mounting system comprising at least one mounting bracket, wherein the at least one mounting bracket comprises a mounting plate and a retention wing, and wherein the retention wing is pivotably connected to the mounting plate such that the mounting plate is movable between a first rotational position in which the retention wing extends upwardly from the mounting plate and a second rotational position in which the retention wing extends downwardly from mounting plate.

The foregoing is provided for purposes of illustrating, explaining, and describing embodiments of the present invention. Further modifications and adaptations to these embodiments will be apparent to those skilled in the art and may be made without departing from the scope or spirit of the invention. Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the invention.

That which is claimed is:

1. A light fixture comprising:
a light engine comprising:
a mounting substrate comprising a front surface, a rear surface opposite the front surface, and at least one aperture extending through the mounting substrate;
at least one light source; and
at least one electronics board; and
a mounting clip comprising:
a central body comprising a first side and a second side opposite the first side;
at least one first finger extending from the central body on the first side; and
at least one second finger extending from the central body on the second side,
wherein the at least one first finger extends through the at least one aperture of the mounting substrate and retains the at least one light source on the front surface of the mounting substrate, and
wherein the at least one second finger retains the at least one electronics board on the second surface of the mounting clip.

2. The light fixture of claim 1, further comprising a fixture housing comprising a pair of side walls defining a housing cavity, wherein each side wall comprises a ledge extending into the housing cavity, wherein the mounting clip further comprises a plurality of attachment arms extending from the second side of the central body, and wherein the plurality of attachment arms engage the ledges of the side walls of the housing such that the light engine is attached to the housing via the mounting clip.

3. The light fixture of claim 1, further comprising:
a fixture housing comprising a pair of side walls and a transverse wall extending between the side walls, wherein the side walls and transverse wall extend between a first end and a second end of the fixture housing, wherein the side walls and transverse wall define a housing cavity, wherein the transverse wall defines an aperture proximate to the first end of the housing, and wherein the light engine is mounted on the fixture housing via the mounting clip; and
an end cap removably mounted to the first end of the fixture housing, wherein the end cap comprises an inner side, an outer side, a lever lock supported on the inner side, and a lever retained on the end cap via the lever lock, wherein the lever is movable along an axis between a first position and a second position, wherein, in the first position, the lever is engaged with the aperture of the fixture housing, and wherein, in the second position, the lever is disengaged from the aperture of the fixture housing.

4. The light fixture of claim 3, wherein the end cap further comprises a first bridge on the inner side, wherein the lever lock is connected to the first bridge and comprises a central portion, wherein the lever comprises a stop proximate a first end and an engagement arm proximate an second end opposite the first end, and wherein the lever is retained on the end cap such that the central portion of the lever lock is between the stop and the engagement arm.

5. The light fixture of claim 1, wherein the mounting clip further comprises a first alignment feature extending from the first side of the central body, wherein the mounting substrate comprises at least one notch, and wherein the first alignment feature is configured to engage the at least one notch of the mounting substrate.

6. The light fixture of claim 1, wherein the mounting clip is a first mounting clip of a plurality of mounting clips and the at least one light source is a first light source of a plurality of light sources, and wherein the plurality of mounting clips retain the plurality of light sources on the mounting substrate.

7. The light fixture of claim 1, wherein the at least one first finger comprises a lip extending inwardly toward a center of the central body, wherein the at least one second finger comprises a lip extending inwardly toward the center of the central body, wherein the mounting clip further comprises an attachment arm extending from the second side of the central body, and wherein the attachment arm comprises a lip extending outwardly away from the center of the central body.

8. A light fixture comprising:
a light engine;
a fixture housing comprising a pair of side walls defining a housing cavity, wherein each side wall comprises a ledge extending into the housing cavity; and
a mounting clip comprising:
a central body comprising a first side and a second side opposite the first side;
at least one first finger extending from the central body on the first side; and
a plurality of attachment arms extending from the central body on the second side,
wherein the at least one first finger is engaged with the light engine and wherein the plurality of attachment arms engage the ledges of the side walls of the housing such that the light engine is attached to the housing via the mounting clip.

9. The light fixture of claim 8, wherein the mounting clip further comprises at least one second finger extending from the central body on the second side, wherein the light engine comprises:
a mounting substrate comprising a front surface, a rear surface opposite the front surface, and at least one aperture extending through the mounting substrate;
at least one light source; and
at least one electronics board,
wherein the at least one first finger engages the at least one light source and retains the at least one light source on the front surface of the mounting substrate, and
wherein the at least one second finger engages the at electronics board.

10. The light fixture of claim 9, wherein the mounting substrate further comprises a pair of reflector wings extending from the front surface of the mounting substrate, and wherein the at least one light source is retained on the mounting substrate between the reflector wings.

11. The light fixture of claim 8, further comprising a mounting system comprising at least one mounting bracket, wherein the at least one mounting bracket comprises a mounting plate and a retention wing, and wherein the retention wing is pivotably connected to the mounting plate so as to be adapted to move between a first rotational position in which the retention wing extends upwardly from the mounting plate and a second rotational position in which the retention wing extends downwardly from mounting plate.

12. The light fixture of claim 11, wherein the housing comprises at least one channel, wherein the mounting plate of the at least one mounting bracket is connected to the housing via the at least one channel, and wherein the mounting plate is adapted to translate along the at least one channel.

13. The light fixture of claim 8, wherein the fixture housing further comprises a transverse wall extending between the side walls, and wherein the light fixture further comprises:
an end cap removably mounted to an end of the fixture housing, wherein the end cap comprises an inner side, an outer side, a lever lock supported on the inner side, and a lever retained on the end cap via the lever lock, wherein the lever is movable along an axis between a first position and a second position, wherein, in the first position, the lever is engaged with the transverse wall of the fixture housing, and wherein, in the second position, the lever is disengaged from the transverse wall of the fixture housing.

14. The light fixture of claim 8, wherein the mounting clip further comprises a first alignment feature extending from the first surface and a second alignment feature extending from the second surface, wherein the first alignment feature is configured to engage an electronics board of the light engine and wherein the second alignment feature is configured to engage a light source of the light engine.

15. A light fixture comprising:
a fixture housing comprising a pair of side walls and a transverse wall extending between the side walls, wherein the side walls and transverse wall extend between a first end and a second end of the fixture housing, and wherein the side walls and transverse wall define a housing cavity; and
a mounting system comprising at least one mounting bracket, wherein the at least one mounting bracket comprises a mounting plate and a retention wing, and wherein the retention wing is pivotably connected to the mounting plate such that the mounting plate is movable between a first rotational position in which the retention wing extends upwardly from the mounting plate and a second rotational position in which the retention wing extends downwardly from mounting plate.

16. The light fixture of claim 15, wherein the transverse wall defines an aperture proximate to the first end of the housing, and wherein the light fixture further comprises an end cap removably mounted to the first end of the fixture housing, wherein the end cap comprises an inner side, an outer side, a lever lock supported on the inner side, and a lever retained on the end cap via the lever lock, wherein the lever is movable along an axis between a first position and a second position, wherein, in the first position, the lever is engaged with the aperture of the fixture housing, and wherein, in the second position, the lever is disengaged from the aperture of the fixture housing.

17. The light fixture of claim 16, wherein the end cap further comprises a first bridge on the inner side, wherein the lever lock is connected to the first bridge and comprises a central portion, wherein the lever comprises a stop and an engagement arm opposite from the stop, and wherein the lever is retained on the end such that the central portion of the lever lock is between the stop and the engagement arm

18. The light fixture of claim 17, wherein the end cap further comprises a second bridge, wherein, in the first position, the second bridge at least partially covers the lever, and wherein, in the second position, the lever is spaced apart from the second bridge.

19. The light fixture of claim 15, wherein the mounting system further comprises an alignment bracket at the second end of the fixture housing, and wherein the alignment feature comprises at least one of a nesting feature or a locking feature configured to engage an adjacent fixture housing.

20. The light fixture of claim 15, further comprising:
a light engine comprising at least one light source and at least one electronics board; and
a mounting clip comprising:
a central body comprising a first side and a second side opposite the first side;
at least one first finger extending from the central body on the first side;
at least one second finger extending from the central body on the second side; and
a plurality of attachment arms extending from the central body on the second side, wherein the at least one first finger engages the at least one light source,
wherein the at least one second finger engages the at least one electronics board, and
wherein the plurality of attachment arms engage the side walls of the housing.
